(19) United States
(12) Patent Application Publication
(10) Pub. No.: US 2010/0115116 A1
(43) Pub. Date: May 6, 2010

(54) SYSTEM AND METHOD FOR SWITCHING COMMUNICATION PROTOCOLS IN ELECTRONIC INTERFACE DEVICES

(75) Inventor: MEHDI ASNAASHARI, Danville, CA (US)

Correspondence Address: DORSEY & WHITNEY LLP;INTELLECTUAL PROPERTY DEPARTMENT, Columbia Center, 701 Fifth Avenue, Suite 6100, SEATTLE, WA, 98104-7043, US

(73) Assignee: MICRON TECHNOLOGY, INC., Boise, ID (US)

(21) Appl. No.: 12/263,863

(22) Filed: Nov. 3, 2008

(51) Int. Cl. G06F 15/16

(52) U.S. Cl. 709/230

(57) ABSTRACT

Methods and systems are disclosed including those that cause an electronic interface device to dynamically switch protocols that it uses to communicate with a host to which the electronic interface device is connected. In one such embodiment, the electronic interface device first attempts using a first communications protocol, such as a CCID protocol. If the host contains a driver for the first communications protocol, the host communicates with the electronic interface device using the first communications protocol. If the host does not contain a driver for the first communications protocol, the electronic interface device attempts using a second communications protocol that is different from the first communications protocol, such as a HID protocol. The host then communicates with the electronic interface device using the second communications protocol. If the electronic interface device communicates with the host using the first communications protocol, it may transmit user authentication data, such as a password, to the host.

### TECHNICAL FIELD

Embodiments of the present invention relate generally to electronic interface devices that can communicate with a host, such as a personal computer system.

### BACKGROUND OF THE INVENTION

Chip cards or integrated circuit cards, both of which are commonly known as smart-cards, TPM (trusted platform Module) ICs, or the like, are devices with an embedded integrated circuit, such as a processor and a non-volatile memory device. The memory device may be, for example, a flash memory device and/or an EEPROM (electrically erasable programmable read-only memory) or the like. The memory device may store user data, and it may store an operating system for the processor as well as smart-card applications, such as electronic banking applications, telephone applications in the case of SIM (subscriber identity module) smart-cards, or the like. The memory device may also store user authentication protocols, which may be used, for example, to allow an authorized individual to log onto a secure network, such as an Ethernet network, or an operating system, such as Windows.® Such devices are commonly known as “tokens.” The memory device may also store personalization data, such as telephone or bank account data or the like, user data, such as financial data or the like, private data, certificates or signatures used in various encryption techniques, etc. User data may be protected using a PIN (personal identification number) or a password as an access control measure. In order to access the protected data stored in the card's memory device, a user must be authenticated by providing the correct PIN or password.

One example of an electronic interface device user authentication protocol that allows logging onto a network or operating system is a smart-card based device or similar interface device having a universal serial bus (“USB”) interface. If the host is configured to use the interface device for operating system or network logon, the host will communicate with the interface device when the interface device is connected to the host. In such case, it will be necessary for the host to include a CCID driver, which is a driver used in some operating systems. For example, Windows Vista® does include a CCID driver, but earlier versions of Windows,® such as Windows XP,® do not include a CCID driver.

The host may also run a client application that performs certain functions. The client application may be, for example, stored in the host, stored in the interface device and downloaded to the host, or downloaded through a network. The function performed by the client application may include user authentication to access protected storage and various Public Key Infrastructure (“PKI”) such as PKCS #11 functions that do not necessarily require CCID driver.

If the interface device is used for operating system or network logon, it will generally enumerate as a CCID-type device and as a mass storage device. As is well-known in the art, enumeration is a process by which an electronic device interfacing with another electronic device defines certain of its operating characteristics used in attempting to communicate with the other device. If the host has a CCID driver installed, it will then communicate with the interface device and prompts user to enter his logon credentials. Once the authentication is successful and the user is logged on, the mass storage of the interface device will be mounted on the host and protected and unprotected storage will be available. In another embodiment, after successful authentication to the host, the client application will prompt user to enter his credentials to access the protected storage.

If an application running on the host detects the lack of a CCID driver in the host, the host will then issue a command for the user to install a CCID driver. If a CCID driver is not available or the user does not have the necessary permission to install it, the interface device may not be used with the host. Therefore, functions that do not require a CCID driver, such as protected storage, will not be available since the interface device uses the same CCID driver to authenticate user to access protected storage. As a result, these USB interface devices cannot be used with a host that does not contain a CCID driver. This limitation reduces the usefulness of these USB interfaces devices outside of, for example, a corporate network in which they are normally used. For example, the user may want to use the interface device as simply an external memory device to transfer data between the interface device and a host. Similar problems also exist for other interface devices performing authentication functions that do not contain all of the components of a smart-card, but instead contain only communications support, non-volatile memory and a simple processor or controller.

There is therefore a need for an interface device that is capable of interfacing with hosts using a greater variety of communications protocols.

### BRIEF DESCRIPTION OF THE DRAWINGS

FIG. 1 is a block diagram of an electronic interface device according to one embodiment of the invention.

FIG. 2 is a flow chart of an embodiment of an application running on the electronic interface device of FIG. 1 or a host that may be used with the electronic interface device of FIG. 1.

FIG. 3 is a flow chart showing the manner in which an embodiment of the electronic interface device of FIG. 1 switches from using a CCID protocol to using a HID protocol.

### DETAILED DESCRIPTION

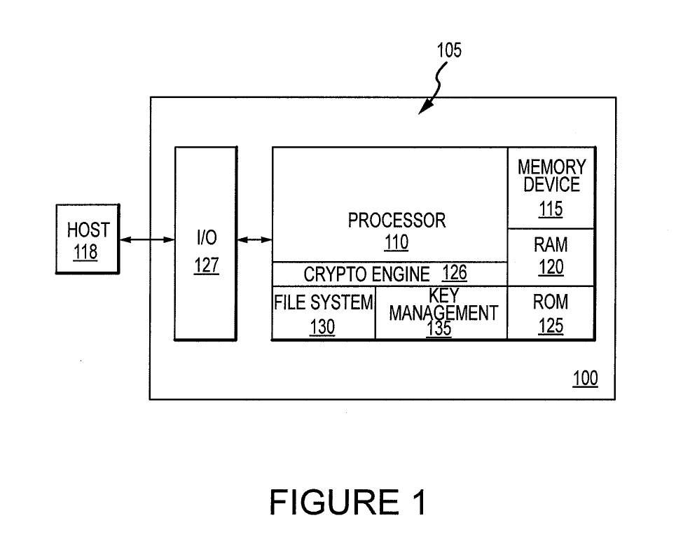

FIG. 1 is a block diagram of an electronic interface device 100 according to one embodiment of the invention. A central processing unit (“CPU”) 105 is embedded in the interface device 100, and it may include a processor 110 and an integrated random access memory (“RAM”) 120, a non-volatile memory 115, such as an EEPROM or flash memory, and a read-only memory (“ROM”) 125. The processor 110 may include a cryptography engine 126, such as an advanced encryption system (“AES”), as a portion of access control circuitry of CPU 105, that can perform AES protocols, user authentication protocols, such as Public Key Infrastructure (“PKI”) authentication, encryption and decryption of data, etc. An input/output interface 127 is in communication with the CPU 105 and may be a USB (universal serial bus) interface for connecting directly to a host 118, such as a personal computer, a contactless interface, an ISO 7816 interface for use with an ISO 7816 card reader, etc. The ROM 125 typically stores the operating system of the interface device 100. The interface device 100 may also include a file management system 130 that may be used to manage the address space of the non-volatile memory 115, and a key management system 135 for managing and storing one or more encryption and/or decryption keys, such as one or more AES encryption and/or decryption keys or the like. The non-volatile memory 115 or the key management system 135 may store private keys, certificates that may include public keys as part of public/private key encryption, applications, such as electronic banking applications, telephone applications, etc. The non-volatile memory 115 may further include upgrades or patches for the interface device operating system.

Although the electronic interface device 100 includes all of the components shown in FIG. 1, other embodiments of an electronic interface device may dispense with many of these components as long as the device has a non-volatile memory, a communications interface of some type for communicating with a host, and a controlling device to control the operation of the electronic interface device, such as a processor, controller or the like. Also, of course, embodiments of the electronic interface device may include components in addition to or in place of the components used in the embodiment of the electronic interface device 100 of FIG. 1.

During operation of the electronic interface device 100, the device is placed in communication with a host 118 via a communications interface, such as a USB port. The electronic interface device 100 may then pass authentication data, such as PIN, password or other authentication identifier, to the host 118. The electronic interface device 100 thus indicates to the host 118 that the user is either authenticated or not authenticated. After user authentication, the host 118 logs the user onto the host and/or onto a network that is connected to the host. Alternatively, the host 118 may cause an operating system to load. For example, if the host 118 is a personal computer system, the host may not load the operating system for the system until the user has been authenticated. The electronic interface device 100 may also be used in connection with a client application running on the host 118. The client application may also provide the user with access to protected data, may decrypt the data using the cryptography engine 126 and an encryption key stored in the key management system 135. Additionally or alternatively, authentication may allow the user to securely sign e-mails using, for example, a public key encryption system.

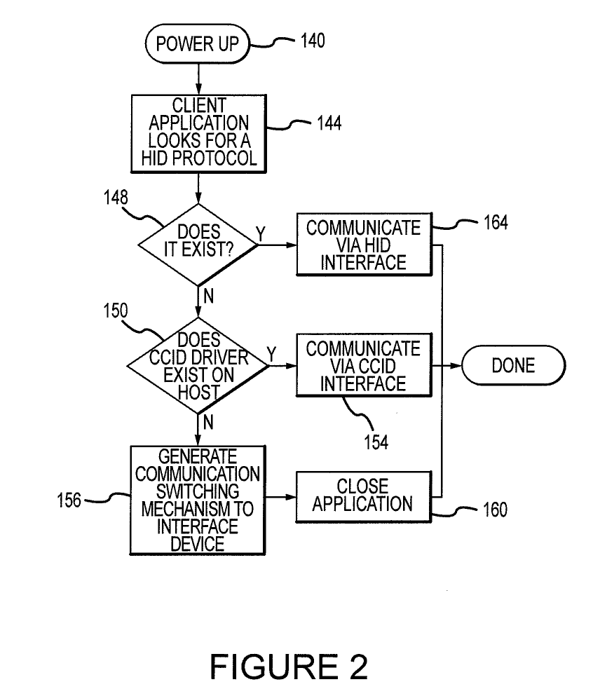

Unlike conventional electronic interface devices performing user authentication, the electronic interface device 100 is able to dynamically alter the communications protocol that it uses to communicate with the host 118. The electronic interface device 100 may be placed in communication with a host 118 that is equipped with a CCID driver. As shown in FIG. 2, after the host 118 has powered up at 140, a client application running on the host 118 or the electronic interface device 100 may determine at 144 whether the electronic interface device 100 is attempting to communicate using a HID protocol. Insofar as the electronic interface device has enumerated using the CCID protocol, the operation branches from 148 to 150 where the application checks to determine if the host 118 is equipped with a CCID driver. If so, the application program branches to 154 where communication between the host 118 and the electronic interface device 100 proceeds using the CCID protocol. This is the normal path followed if the electronic interface device 100 is interfacing with a host 118 containing a CCID driver. If, however, if the application determines at 144 that the host 118 is not equipped with a CCID driver, the application branches to 156 where it passes a command to the electronic interface device to disconnect and re-enumerate using the HID protocol. This can be accomplished by the host passing one or more commands to the electronic interface device 100. The application is also closed at 160. The electronic interface device 100 will then re-enumerate as an HID device, and the application will then determine at 148 that the host 118 is now using the HID protocol. The application therefore branches to 164 where it causes the communication between the host 118 and the electronic interface device 100 to commence using the HID protocol. The electronic interface device 100 may then be used as a mass storage device and possibly for other functions such as protected data storage, although it may not be able to use the PKI features of the device 100. Thus, unlike conventional electronic interface devices, the electronic interface device 100 is able to enumerate as a CCID device to take advantage of PKI authentication features, yet is able to switch to the HID protocol if the host 118 is not equipped with a CCID driver. The interface device 100 can then be used as a mass storage device. Therefore, unlike conventional electronic interface devices, the electronic interface device 100 can still be used even if a CCID driver is not available in the host 118.

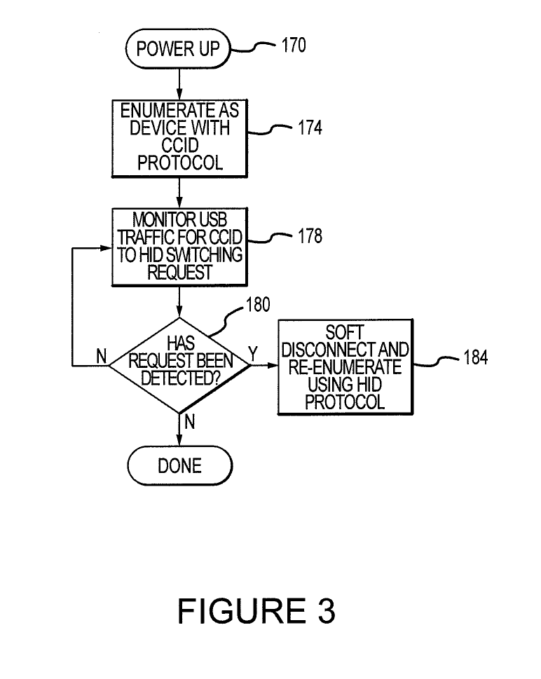

One embodiment of the operation of the electronic interface device 100 when interfacing with a host 118 is shown in FIG. 3. After the device 100 powers up at 170, it enumerates as a CCID device at 174, as explained above with reference to FIG. 2. The electronic interface device then monitors communications with the host 118 at 178 to detect at 180 a command by the host 118 to switch to the HID protocol. As previously explained with reference to FIG. 2, the host 118 provides this command at 156 if the application running on the host 118 or device 100 has determined at 150 that the host 118 is not equipped with a CCID driver. In response to receiving the command from the host 118, the electronic interface device 100 re-enumerates as a HID device equipped with a mass storage device at 184. The electronic interface device then implements a soft disconnect from the host 118 at 184 and re-enumerates as a HID device equipped with a mass storage device. The electronic interface device 100 may then be used with a host 118 that does not have a CCID driver, as explained above with reference to FIG. 2.

From the foregoing it will be appreciated that, although specific embodiments of the invention have been described herein for purposes of illustration, various modifications may be made without deviating from the spirit and scope of the invention. For example, although the electronic interface device embodiment shown in FIG. 1 uses a USB port to interface with a host, other types of communication interfaces, such as communications ports and/or communication links, may be used. Also, the description of the electronic interface device embodiment shown in FIG. 1 describes the use of a personal computer as the host, the host may be another type of electronic interface device such as a smart-card reader, a bank teller machine, or a security system, to name a few. Accordingly, the invention is not limited except as by the appended claims.

What is claimed is:

1. An electronic interface device, comprising:
a non-volatile memory;
a communications interface coupled to the non-volatile memory device, the communications interface being configured for communications alternately using a first communications protocol and a second communications protocol that is different from the first communications protocol; and
a controlling device configured to control the operation of the communications interface and the non-volatile memory device, the controlling device being structured to cause the communications interface to initially attempt to communicate using the second communications protocol, and, if the communications interface is unable to communicate using the second communications protocol, to cause the communications interface to attempt to communicate using the first communications protocol.

2. The electronic interface device of claim 1 wherein the second communications protocol comprises a CCID protocol.

3. The electronic interface device of claim 2 wherein the first communications protocol comprises a HID protocol.

4. The electronic interface device of claim 1 wherein, after causing the communications interface to attempt to communicate using the second communications protocol, the controlling device is operable to cause the communications interface to attempt to communicate using the first communications protocol responsive to a request command.

5. The electronic interface device of claim 1 wherein the controlling device comprises:
a processor; and
an application program stored in the non-volatile memory.

6. The electronic interface device of claim 1 wherein the electronic interface device further comprises a cryptographic engine and a cryptographic key management system.

7. An electronic system, comprising:
a host; and
an electronic interface device having a non-volatile memory and a communications interface coupled to the non-volatile memory device and the host, the communications interface communicating with the host using one of a first communications protocol and a second communications protocol that is different from the first communications protocol, the communications interface initially attempting to use the second communications protocol, and, if the host is not equipped with a driver for the second communications protocol, the communications interface attempts to communicate using the first communications protocol.

8. The electronic system of claim 7 wherein the communications interface comprises a universal serial bus port.

9. The electronic system of claim 8 wherein the second communications protocol comprises a CCID protocol.

10. The electronic system of claim 7 wherein the host contains a driver for the first communications protocol but is not equipped with a driver for the second communications protocol, and wherein the host is operable to run a software application that detects an attempt by the electronic interface device to use a protocol other than the first communications protocol, and, in response to detecting an attempt by the electronic interface device to use a protocol other than the first communications protocol, transmits a switching command to the electronic interface device, and wherein the communications interface is operable responsive to receiving the switching command to attempt to use the first communications protocol.

11. The electronic system of claim 7 wherein the host is running and application program that is operable to:
detect if the interface device is attempting to communicate using the first protocol;
if the application program detects that the interface device is attempting to communicate using the first protocol, cause the host to communicate with the electronic interface device using the first protocol;
if the application program does not detect that the interface device has attempted to communicate using the first protocol, the application program detects if the interface device has attempted to communicate using the second protocol;
if the application program detects that the communications interface device has attempted to communicate using the second protocol and the host is able to communicate using the second protocol, the application program causes the host to communicate with the electronic interface device using the second protocol; and
if the application program detects that the communications interface device has attempted to communicate using a protocol other than the first protocol and the host is unable to communicate using the second protocol, the application program causes the host to attempt to communicate with the interface device using the first protocol.

12. The electronic system of claim 7 wherein the electronic interface device further comprises user authentication data and is operable to send the user authentication data to the host responsive to communicating with the host using the second protocol, and wherein the host is operable to load an operating system on the host in response to receiving the user authentication data from the electronic interface device.

13. The electronic system of claim 7 wherein the host is connected to a network, wherein the electronic interface device further comprises user authentication data and is operable to send the user authentication data to the host responsive to communicating with the host using the second protocol, and wherein the host is operable to log a user onto one of the network and the host in response to receiving the user authentication data from the electronic interface device.

14. A method of establishing communications between an electronic interface device and a host to which the electronic interface device is coupled, the method comprising:
determining whether the host is able to communicate using the first communications protocol; and
in response to determining that the host is unable to communicate using the first communications protocol, communicating with the host using a second communications protocol that is different from the first communications protocol.

15. The method of claim 14 wherein the communicating with a second protocol is further in response to receiving a specific command from the host.

16. The method of claim 14 wherein the first communications protocol comprises a CCID protocol, and wherein the second communications protocol comprises a HID protocol.

17. The method of claim 14, further comprising:
before sending data from the electronic interface device to the host indicative of the first communications protocol, determining in the host if the electronic interface device is sending the data from the electronic interface device to the host indicative of the second communications protocol; and
if the determination is made that the electronic interface device is sending data from the electronic interface device to the host indicative of the second communications protocol, establishing communications between the electronic interface device and the host using the second communications protocol.

18. A method of operating a host, comprising:
coupling an electronic interface device to the host, the electronic interface device storing user authentication data;
causing the electronic interface device to attempt using a first communications protocol;
if the host is unable to communicate using the first communications protocol, causing the electronic interface device to attempt using a second communications protocol that is different from the first communications protocol;
if the host is able to communicate using the first communications protocol, sending the user authentication data from the electronic interface device to the host;
if the host is unable to communicate using the first communications protocol, inhibiting the electronic interface device from sending the user authentication data to the host;
in response to the host receiving the user authentication data from the electronic interface device, performing a first set of operations in the host; and
in response to the host not receiving the user authentication data from the electronic interface device, performing only a second set of operations in the host that are more limited than the first set of operations.

19. The method of claim 18 wherein the first set of operations include logging a user onto a network to which the host is coupled, and wherein the second set of operations does not include logging the user onto the network to which the host is coupled.

20. The method of claim 18 wherein the second set of operations comprise transferring data between the electronic interface device and the host.

21. The method of claim 18 further comprising:
if the host is able to communicate using the first communications protocol, establishing communications between the host and the electronic interface device using the first communications protocol; and
if the host is unable to communicate using the first communications protocol, establishing communications between the host and the electronic interface device using the second communications protocol.

22. A method comprising:
determining whether an electronic interface device is attempting to communicate using a first protocol and, if so, communicating using the first protocol;
determining if a host is equipped to communicate using a second protocol if it is determined that the interface device is not attempting to communicate using the first protocol and, if so, communicating using the second protocol;

23. The method of claim 22, further comprising passing a request command to the interface device to communicate using the first protocol if it is determined that the host is not equipped to communicate using the second protocol.

24. A method comprising:
monitoring communication between a host and an electronic interface device to detect a request command to switch to another communication protocol; and
attempting to communicate using the other communication protocol if the request is detected.

25. The method of claim 24, further comprising:
determining whether the host is equipped to communicate using a specific protocol; and
if it is determined that the host is not equipped to communicate using the specific protocol, providing the request command.
